(19) United States
(12) Patent Application Publication
(10) Pub. No.: US 2024/0052137 A2
(43) Pub. Date: Feb. 15, 2024

(54) ANTI-AGEING ADDITIVES FOR BITUMEN

(71) Applicant: SHELL OIL COMPANY, Houston, TX (US)

(72) Inventors: Dawid John D'MELO, Bangalore (IN); Richard Ernest TAYLOR, London (GB); Bulent TUGAL, London (GB)

(73) Assignee: (omitted)

(21) Appl. No.: 18/004,692

(22) PCT Filed: Jul. 30, 2021
(86) PCT No.: PCT/EP2021/071457

§ 371 Date: Jan. 9, 2023

(30) Foreign Application Priority Data
Jul. 31, 2020 (IN) 202041032887

(51) Int. Cl. C08K 5/526; C08K 5/372

(52) U.S. Cl. CPC C08K 5/526; C08K 5/372

(57) ABSTRACT

The invention relates to an additive composition, wherein the additive composition comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether. The invention additionally relates to a bituminous composition comprising anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether. The invention also relates to an asphalt composition comprising the bituminous composition with resistance to short-term and long-term chemical ageing. The invention further relates to the use of an additive composition to reduce short-term and long-term chemical ageing of the bituminous compositions.

### FIELD OF THE INVENTION

The invention relates to an additive composition suitable for reducing short- and long-term ageing of bituminous compositions. The invention additionally relates to a bituminous composition with resistance to short-term and long-term chemical ageing. The invention also relates to an asphalt composition comprising a bituminous composition with resistance to short-term and long-term chemical ageing. The invention further relates to the use of an additive composition to reduce short-term and long-term chemical ageing of a bituminous composition.

### BACKGROUND OF THE INVENTION

Bitumen is a tarlike mixture of hydrocarbons, which may occur naturally, or may be a petroleum/crude oil distillation product. Depending on the temperature that it is exposed to, it may be a viscous liquid, or a solid, and it softens gradually when heated.

Bitumen is a complex mixture, comprising organic molecules such as aliphatic and aromatic derivatives. Bitumen also comprises trace amounts of metals such as nickel, vanadium and iron among other metals. These are typically present in the bitumen as metallic salts, oxides or in porphyrin structures. The interactions between its constituent molecules confer to a given batch of bitumen its unique properties, and consequently how it behaves under different conditions that the bitumen may be subjected to. The composition of different bitumen batches vary depending on at least the source of petroleum/crude oil used to produce it, as well as the chemical modifications that it has been subjected to during its manufacture.

One way of differentiating between different bitumens is by their saturate, aromatic, resin and asphaltene content (referred in the art as “SARA”). Mixing bitumen with n-heptane leads to a heptane-soluble fraction that comprises ‘maltenes’, and a heptane-insoluble fraction that comprises ‘asphaltenes’. The maltene fraction contains the saturates, aromatics and resin portions of bitumen. Depending on its petroleum/crude oil source and the chemical modifications that a batch of bitumen has gone through during its manufacture, the proportions of these fractions with respect to each other vary.

Bitumen can be regarded as a colloidal system, consisting of asphaltene micelles dispersed or dissolved in a maltene matrix. When so-called ‘peptised’, asphaltenes tend to be more dispersed in the maltene matrix. Lesser peptised asphaltenes may associate with one another to form open packed structures of linked micelles. Due to at least such structural behaviour, the degree to which the asphaltenes are peptised affects the viscosity of the bitumen, and therefore the bitumen's physical behaviour.

Bitumen may be used as a binder in a variety of applications. For example, it may be combined with aggregate to make asphalt for producing paved roads. Alternatively, bitumen may be used in so-called industrial applications such as roofing, flooring or sealing.

During asphalt production, molten bitumen or a molten bituminous composition is mixed with hot aggregates such that a film of bitumen coats the aggregates to form a hot asphalt mixture. The hot asphalt mixture is then transported to the paving site where it is uniformly applied over a surface and compacted to a desired level to produce the pavement.

The coating of aggregates with bitumen increases the surface area to volume ratio of the bitumen, which in turn increases its exposure to external factors, such as air, making it more susceptible to oxidation. Such an oxidation process is referred to as “short-term ageing” or “short-term chemical ageing”, and is exacerbated by the elevated temperature of the asphalt mixture.

During the service life of an installed pavement, its bitumen is subjected to further oxidation, a process referred to as “long-term ageing” or “long-term chemical ageing”. Compared to short-term ageing, long-term ageing occurs at lower temperatures, and over longer periods.

It has been established that the ‘Rolling Thin Film Oven Test’ (“RTFOT”), and the ‘Thin Film Oven Test’ (“TFOT”) are suitable laboratory protocols that simulate short-term ageing. However, they are not suitable for simulating long-term ageing. Instead, long-term ageing may be simulated in the laboratory by ‘Pressure Ageing Vessel’ (“PAV”), a process that gives an indication of how a bitumen under investigation may be affected by about 5 years' of long-term-ageing per cycle of PAV treatment. All such techniques will be familiar to a person skilled in the art, and are in any case described in the “Shell Bitumen Handbook”, sixth edition, 2015, ISBN 978-0-7277-5837-8, and are reviewed by G. D. Airey in “Bituminous Pavement Materials”, International Journal of Pavement Engineering 4(3):165-176, September 2003.

Both short- and long-term ageing increase stiffness of a pavement beyond what it was intended or designed to be. This can result in premature failure of the pavement arising from fatigue failure, ravelling or potentially higher crack propagation, leading to catastrophic pavement failure. A deferment of these defects will increase the service life of the pavement and lower its maintenance and remediation costs.

The actual way bitumen oxidation proceeds is not fully understood. However, without being bound to any particular theory, it is thought that oxidation primarily increases the level of free radicals in bitumen. The generated free radicals in turn react other bitumen constituents leading to the formation of oxidation by-products that have, for example, polar groups such as ketones, sulphoxides, acid anhydrides and carboxyl. These by-products in turn interact with various other bitumen constituents, leading to a bitumen with substantially different properties, such as but not limited to, increased stiffness.

One way of reducing the adverse effects of bitumen oxidation may be by incorporating into bitumen anti-oxidants.

“Anti-oxidants” is a general term used to describe a range of compounds with functional groups such as, but not limited to, phenols, amines, phosphites, thioesters and thioalkane. Such functional groups can react with the primary products of bitumen oxidation, such as but not limited to free radicals, and reduce their ability to change properties of bitumens. This type of anti-oxidants are referred to herein as “primary anti-oxidants”. Examples of this type of anti-oxidants include, but not limited to, tris (2,4-ditert butyl) phenyl phosphite and 3,3′-thiodipropionic acid dioctadecylester.

Anti-oxidants may be incorporated into bituminous composition, for example, JP2001192560 discloses a block co-polymer-modified asphalt composition with reduced polymer melting time and improved processability. The asphalt composition may include anti-oxidants and stabilizers. The anti-oxidant may be phenol-based anti-oxidant, sulfur-based anti-oxidant, amine-based anti-oxidant, quinoline-based anti-oxidant, phosphorus-based anti-oxidant or the like. An example of the sulfur-based anti-oxidant may be distearylthiodipropionate, and examples of the phosphorus anti-oxidant may be triphenyl phosphite, tris (nonylphenyl) phosphite, tris (2-ethylhexyl) phosphite or tris (2,4-t-di-t-butylphenyl) phosphite.

U.S. Pat. No. 4,994,508 and EP0299499A2 discloses a composition comprising: (a) a hydrogenated block co-polymer (as described therein); and (b) at least one thermoplastic substance selected from: (i) tackifier resins, (ii) thermoplastic resins, and (iii) bituminous material. The composition may contain tris(2,4-di-tert-butylphenyl)phosphite and distearyl-3,3′-thiodipropionic acid ester.

Mainly due to their levels in bitumen, their degree of peptizing, as well as their association within the maltene matrix with each other and/or with other bitumen constituents, it is known that asphaltenes play a significant part in determining bitumen properties, such as, but not limited to, viscosity.

It is also known that some compounds, generally referred to as asphaltene dispersants, interact with asphaltenes to influence asphaltene interactions with each other and/or with other bitumen constituents, for example by affecting their dispersion within bitumen. Examples of asphaltene dispersants include, but not limited to, polyethylene glycol monoalkyl ether. U.S. Pat. No. 3,635,863 concerns a method for making a polymer/rubber modified bituminous material that comprises a stabiliser to improve the dispersion of the elastomeric polymer and of the synthetic rubber incorporated therein, wherein the stabiliser is sodium or potassium rosin soap, polyoxyethylated nonyl-phenol, polyoxyethylene tridecyl alcohol, polyoxyethylene sorbitan stearate, tristearate, oleate or trioleate, nonyl-phenol or dodecyl-phenol polyethylene glycol ether, or ethoxy sulphate.

The present inventors have sought to find additives, in particular anti-oxidants, which are effective in bituminous compositions by providing to them resistance to short- and long-term chemical ageing. However, they have found that not every anti-oxidant is effective in reducing ageing of every bituminous composition. In particular the inventors have determined that even for those anti-oxidants that appear to be effective in reducing bitumen ageing, the level of their effect is not the same in different bitumens, and may even be non-effective in some bitumens.

In seeking to provide resistance to short- and long-term chemical ageing to bituminous compositions irrespective of their origin and the process(es) by which they were manufactured, the inventors additionally sought to determine whether manipulating asphaltene interactions within bitumens/bituminous compositions may contribute to reducing short- and long-term chemical ageing of bitumens/bituminous compositions. In seeking that, the present inventors surprisingly discovered that a combination of two primary anti-oxidants and an asphaltene dispersant provided to bitumens/bituminous compositions resistance to short-term and long-term chemical ageing irrespective of the origin of the bitumen(s) that comprise the bituminous composition, and irrespective of the chemical processing that the constituent bitumen(s) went through during their manufacture.

### SUMMARY OF THE INVENTION

Accordingly, the present invention concerns an additive composition suitable for reducing short- and long-term ageing of bituminous compositions, wherein the additive composition comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is a polyalkylene glycol monoalkyl ether.

The present invention additionally concerns a bituminous composition comprising anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether.

The present invention also concerns an asphalt composition comprising a bituminous composition comprising anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether.

The present invention further concerns the use of an additive composition to reduce short- and long-term ageing of a bituminous composition, wherein the additive composition comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether.

### BRIEF DESCRIPTION OF THE DRAWINGS

FIG. 1 illustrates the variability in the levels of resistance to short-term ageing of different bitumens provided to them by different individual additives.

FIG. 2 illustrates the levels of resistance to short-term ageing of different bituminous compositions provided to them by the additive composition according the present invention.

FIG. 3 illustrates the levels of resistance to short- and long-term ageing of bituminous compositions comprising the additive composition according the present invention, when used at a lower concentration.

FIG. 4 illustrates the levels of resistance to short- and long-term ageing of a bituminous composition comprising the additive composition according the present invention, when used at a higher concentration.

### DETAILED DESCRIPTION OF THE INVENTION

Bitumen is a complex mixture of hydrocarbons and their derivatives, which may occur naturally, or may be a petroleum/crude oil distillation product. Depending on its source, at ambient temperatures bitumen can be a viscous liquid or a solid. Its physical state softens gradually when heated, making it a useful material, especially for construction applications. Bitumen as a construction material is generally a petroleum/crude oil distillation product, thereby having specific reproduceable physical and chemical properties. Bitumen is used as a binder in a variety of applications ranging from roofing, flooring to sealing. Bitumen may be combined with aggregates to provide asphalt that can be used for, for example, manufacturing roads and airport runways.

The inventors have sought to provide to bituminous compositions resistance to short- and long-term chemical ageing, irrespective of, for example, the bituminous composition's origin and the process(es) by which it was manufactured. In particular, they sought to formulate a universally effective additive composition package whose such anti-ageing effects provided to the bituminous composition is less prone to variability due to the components of the bituminous composition, the bitumen's origin and the process(es) by which it was manufactured, so that such an additive composition package can be incorporated into any bituminous composition and provide to it an acceptable level of resistance to short- and long-term bitumen ageing, for example, during and after being incorporated into asphalt compositions.

The present invention provides an additive composition, wherein the additive composition comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is a polyalkylene glycol monoalkyl ether.

The anti-oxidants comprising the additive composition according to the present invention are tris (2,4-ditert butyl) phenyl phosphite and 3,3′-thiodipropionic acid dioctadecylester. The 3,3′-thiodipropionic acid dioctadecylester may also be referred to as, for example, “propanoic acid, 3′-thiobis dioctadecyl ester” or “distearyl thiodipropionate” or “dioctadecyl 3,3′-thiodipropionate” and/or “octadecyl 3-(3-octadecoxy-3-oxopropyl)sulfanylpropanoate”. In any event, 3,3′-thiodipropionic acid dioctadecylester may be commercially available under the trade name of “Irganox PS802FL”™.

Tris (2,4-ditert butyl) phenyl phosphite is thought to react with the the primary products of bitumen oxidation, such as but not limited to free radicals, and reduce their ability to change properties of bitumens. As such, it can be regarded as a type of primary anti-oxidant, as discussed above, and can be used as an anti-oxidant. As with Tris (2,4-ditert butyl) phenyl phosphite, 3,3′-thiodipropionic acid dioctadecylester is also a primary anti-oxidant, with activity as discussed.

The asphaltene dispersant comprising the additive composition according to the present invention is a polyalkylene glycol monoalkyl ether. The polyalkylene moiety of the polyalkylene glycol monoalkyl ether may be a polyethylene, polypropylene or a polybutylene. Preferably, the polyalkylene moiety of the polyalkylene glycol monoalkyl ether is polyethylene, i.e. polyethylene glycol monoalkyl ether, which may also be referred to as “iso-tridecyl alchohol polyglycol ether (8EO)” and/or “oligoethylene glycol monoalkyl ether” and/or “polyethylene glycol monoalkyl ether” and/or “ethoxylated isotridecyl alcohol, polyglycol ether” and/or “polyethylene glycol monoalkyl ether”. In any event, polyethylene glycol monoalkyl ether may be commercially available under the trade name of “Genapol X-80”™.

The additive composition may also comprise, for example, but not limited to, a petroleum flux, to assist the dissolution of the anti-oxidants and the asphaltene dispersant in it, as well as their incorporation into bituminous compositions.

The inventors have found that the anti-oxidant tris (2,4-ditert butyl) phenyl phosphite by itself provides to bituminous compositions of different origins and/or manufacturing processes resistance to short- and long-term chemical ageing.

Similarly, the inventors have found that the anti-oxidant 3,3′-thiodipropionic acid dioctadecylester by itself provides to bituminous compositions of different origins and/or manufacturing processes resistance to short- and long-term chemical ageing.

The inventors also found that asphaltene dispersant polyethylene glycol monoalkyl ether by itself provides to bituminous compositions of different origins and/or manufacturing processes resistance to short- and long-term chemical ageing.

However, with these anti-oxidants and the asphaltene dispersant, the level of such resistance varied between bitumens of different origins and the process(es) by which they were manufactured.

Unexpectedly, the inventors found that the combination of primary anti-oxidants with an asphaltene dispersant, namely tris (2,4-ditert butyl) phenyl phosphite, 3,3′-thiodipropionic acid dioctadecylester with polyethylene glycol monoalkyl ether, provided to bituminous compositions resistance to short- and long-term chemical ageing that was less prone to variability due to the bitumen components of the bituminous composition, their origin and the process(es) by which they were manufactured.

The inventors found that the extent of the anti-ageing effect provided by said combination of anti-oxidants and the asphaltene dispersant for some bitumens could be less than the extent conferred by some individual anti-oxidants, however said combination reduced the variability in anti-ageing seen across different bitumens, thus making the said combination more widely effective.

The additive composition can be used in the form of a pre-mixed concentrated masterbatch or an additive composition package, to be diluted into a bituminous composition, for example, to reduce short- and long-term ageing of bituminous compositions, as described below.

The present invention additionally provides a bituminous composition comprising anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether.

The bituminous composition comprises bitumen. Bitumen may be a by-product of petroleum/crude oil refining, as a natural product, or mixtures thereof. The bitumen may be straight run bitumen, thermally cracked residue or precipitation bitumen, e.g. from propane de-asphalting process. The bituminous composition may also be a blend of more than one bitumen. The bituminous composition may comprise a natural rubber or crumb rubber modified binder, a penetration grade binder, and/or may comprise polymers, waxes and/or surfactants.

The bituminous composition according to the present invention can be used for asphalt production, as well as for industrial applications such as roofing, flooring or sealing. Accordingly, an asphalt composition comprising the bituminous composition can be used for road paving applications.

The anti-oxidants comprising the bituminous composition of the present invention are tris (2,4-ditert butyl) phenyl phosphite and 3,3′-thiodipropionic acid dioctadecylester, both as described above regarding the additive composition.

The asphaltene dispersant comprising the bituminous composition of the present invention is polyethylene glycol monoalkyl ether, as described above regarding the additive composition.

The amount of each one of the above-mentioned anti-oxidants in the bituminous composition in relation to the weight of the bituminous composition is at least 0.05% w/w, preferably at least 0.15% w/w, more preferably at least 0.2% w/w, even more preferably at least 0.25% w/w, most preferably at least 0.3% w/w.

The amount of each one of the above-mentioned anti-oxidants in the bituminous composition in relation to the weight of the bituminous composition is at most 2% w/w, preferably at most 1.75% w/w, more preferably at most 1.5% w/w, even more preferably at most 1.25% w/w, most preferably at most 1% w/w.

Each one of the above-mentioned anti-oxidants may be incorporated into the bituminous composition in a different amount to the other, as long as each one is at an amount that falls within the concentration ranges described above.

Each one of the above-mentioned anti-oxidants may be incorporated into the bituminous composition by any method known to the person skilled in the art, for example by any low shear mixing method. Preferably, the anti-oxidants are incorporated into the bituminous composition so that they are almost homogeneously dispersed, or more preferably, the anti-oxidants are incorporated into the bituminous composition so that they are homogeneously dispersed. These anti-oxidants, whether individually or together in any combination, may be pre-dissolved in, for example, but not limited to, a petroleum flux, whether or not in combination with the asphaltene dispersant, and then incorporated into the bituminous composition by diluting it to a required concentration as described below.

The one or more anti-oxidants is incorporated into the molten bituminous composition, for example at a temperature of at least 140° C., or above.

The amount of the above-mentioned asphaltene dispersant in the bituminous composition in relation to the weight of the bituminous composition is at least 0.05% w/w, preferably at least 0.15% w/w, more preferably at least 0.2% w/w, even more preferably at least 0.25% w/w, most preferably at least 0.3% w/w.

The amount of the above-mentioned asphaltene dispersant in the bituminous composition in relation to the weight of the bituminous composition is at most 2% w/w, preferably at most 1.75% w/w, more preferably at most 1.5% w/w, even more preferably at most 1.25% w/w, most preferably at most 1% w/w.

The amount of the above-mentioned asphaltene dispersant incorporated into the bituminous composition may be different to the amount of each one of the anti-oxidants, as long as each one is at an amount that falls within the concentration ranges described above.

The asphaltene dispersant may be incorporated into the bituminous composition by any method known to the person skilled in the art, for example by any low shear mixing method. Preferably, the asphaltene dispersant is incorporated into the bituminous composition so that it is almost homogeneously dispersed, more preferably, the asphaltene dispersant is incorporated into the bituminous composition so that it is homogeneously dispersed. The asphaltene dispersant may be pre-dissolved in, for example, but not limited to, a petroleum flux, which may comprise the above-mentioned anti-oxidants individually or together in any combination, and then incorporated into the bituminous composition by diluting it to a required concentration as described above.

The asphaltene dispersant is incorporated into the molten bituminous composition, for example at a temperature of at least 140° C., or above.

The amount/concentration of each of the anti-oxidants and the asphaltene dispersant in the bituminous composition with respect to each other may vary as long as their amounts/concentrations fall within the concentration ranges described above for the bituminous composition.

Tris (2,4-ditert butyl) phenyl phosphite is commonly procured as a solid, 3,3′-thiodipropionic acid, dioctadecylester is also commonly procured as a solid, and polyethylene glycol monoalkyl ether is commonly procured as a liquid.

The tris (2,4-ditert butyl) phenyl phosphite, 3,3′-thiodipropionic acid dioctadecylester and/or polyethylene glycol monoalkyl ether may be mixed together prior to their incorporation into the bituminous composition to form a pre-mixed concentrated masterbatch, or additive composition package, which may be incorporated into the bituminous composition by diluting it to a required concentration such that each one in the bituminous composition is at an amount/concentration that falls within the concentration ranges described above.

The amount/concentration in the pre-mixed concentrated masterbatch or additive composition package of each of the anti-oxidants and the asphaltene dispersant with respect to each other may vary as long as, once the pre-mixed concentrated masterbatch or additive composition package diluted into the bituminous composition, their individual amounts/concentrations fall within the concentration ranges described above for the bituminous composition.

The anti-oxidants and the asphaltene dispersant may be mixed together prior to their incorporation into the bituminous composition (i.e. as a pre-mixed concentrated masterbatch or additive composition package), for example, but not limited to, in a petroleum flux, and then incorporated into the bituminous composition by diluting it to a required concentration such that each one in the bituminous composition is at an amount/concentration that falls within the concentration ranges described above.

The present invention also relates to an asphalt composition comprising a bituminous composition with resistance to short-term and long-term chemical ageing. The bituminous composition comprising the asphalt composition is as described above, and comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether, all as described above.

The term ‘asphalt’ as used herein refers to a mixture comprising bitumen or a bituminous composition, and aggregates for the purpose of paving roads, such that during asphalt production, molten bitumen/bituminous composition is mixed with hot aggregates so that a thin film of the bitumen/bituminous composition coats the aggregates. The hot asphalt mixture is then transported to the paving site where it is uniformly applied over a surface and compacted to a desired level to produce the pavement.

The asphalt composition may comprise a natural rubber or crumb rubber modified bituminous composition, a penetration grade bituminous composition, and/or a bituminous composition comprising polymers, waxes and/or surfactants.

The amount/concentrations of the anti-oxidants and the asphaltene dispersant comprising the asphalt composition are each considered with respect to their concentration in the bitumen/bituminous composition comprising the asphalt composition, in such amount/concentration that each one is at an amount/concentration that falls within the concentration ranges described above for the bituminous composition.

The amount/concentration of each of the anti-oxidants and the asphaltene dispersant with respect to each other may vary as long as its amount/concentration falls within the concentration ranges described above for the bituminous composition.

Each of the anti-oxidants and the asphaltene dispersant, may be incorporated into the molten bituminous composition comprising the asphalt composition by any method known to the person skilled in the art, for example by any low shear mixing method. Preferably, they are incorporated into the bituminous composition so that they are almost homogeneously dispersed throughout the bituminous composition, more preferably, they are incorporated into the bituminous composition so that they are homogeneously dispersed throughout the bituminous composition. If the anti-oxidants and the asphaltene dispersant are present in the form of a pre-mixed concentrated masterbatch/additive composition package, as described above, such mixture may also be incorporated into the bituminous composition in a similar manner, such that their individual amounts/concentrations are within the ranges described above.

Each of the anti-oxidants and the asphaltene dispersant may be incorporated into the molten bituminous composition comprising the asphalt composition, for example, at a temperature of at least 140° C., or above.

The present invention further concerns the use of an additive composition to reduce short- and long-term ageing of a bituminous composition, wherein the additive composition comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether.

The bituminous composition comprises bitumen. Bitumen may be a by-product of petroleum/crude oil refining, as a natural product, or mixtures thereof. The bitumen may be straight run bitumen, thermally cracked residue or precipitation bitumen, e.g. from propane de-asphalting process. The bituminous composition may also be a blend of more than one bitumen. The bituminous composition may comprise a natural rubber or crumb rubber modified binder, a penetration grade binder, and/or may comprise polymers, waxes and/or surfactants.

The bituminous composition according to the present invention can be used for asphalt production, as well as for industrial applications such as roofing, flooring or sealing. Accordingly, an asphalt composition comprising the bituminous composition can be used for road paving applications.

The additive composition is used to reduce short- and long-term ageing of the bituminous compositions by incorporating the additive composition into the bituminous composition such that when incorporated, the final amount/concentration of the anti-oxidants and the asphaltene dispersant in the bituminous composition is at amount/concentration falls within the concentration ranges described below. The final amount/concentration of the anti-oxidants and the asphaltene dispersant in the bituminous composition may vary with respect to each other, as long as these are within the concentration ranges described below.

Bituminous compositions comprising the additive composition may be used to make the above-mentioned asphalt composition.

The additive composition is used to reduce short- and long-term ageing of the bituminous compositions by incorporating the additive composition into the bituminous composition such that when incorporated, the final amount in relation to the weight of the bituminous composition of each of the anti-oxidants and the asphaltene dispersant in the bituminous composition is at least 0.05% w/w, preferably at least 0.15% w/w, more preferably at least 0.2% w/w, even more preferably at least 0.25% w/w, most preferably at least 0.3% w/w.

When the additive composition is incorporated into the bituminous composition, the amount of each one the anti-oxidants and the asphaltene dispersant in the bituminous composition in relation to the weight of the bituminous composition is at most 2% w/w, preferably at most 1.75% w/w, more preferably at most 1.5% w/w, even more preferably at most 1.25% w/w, most preferably at most 1% w/w.

The amount/concentration of each of the anti-oxidants and the asphaltene dispersant with respect to each other may vary as long as, when the additive composition is incorporated into the bituminous composition, their amount/concentrations is within the range described above.

The additive composition can be incorporated into molten bituminous composition, for example, at a temperature of at least 140° C., or above.

The additive composition may be incorporated into the bituminous composition by any method known to the person skilled in the art, for example by any low shear mixing method, so that the additive composition is almost homogeneously dispersed in the bituminous composition, and more preferably, the additive composition is homogeneously dispersed in the bituminous composition.

The additive composition may be incorporated into the bituminous composition as a pre-mixed concentrated masterbatch/additive composition package, as described above, which may comprise a petroleum flux to assist its preparation and/or the dissolution of the anti-oxidants and the asphaltene dispersant in the bituminous composition.

### DETAILED DESCRIPTION OF THE DRAWINGS

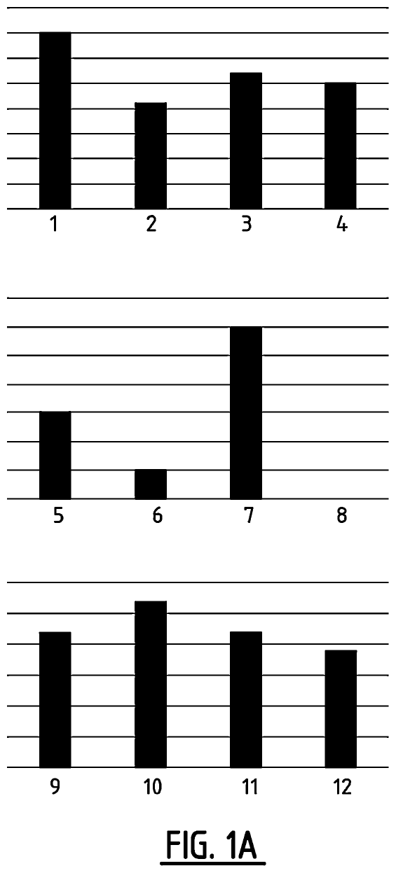

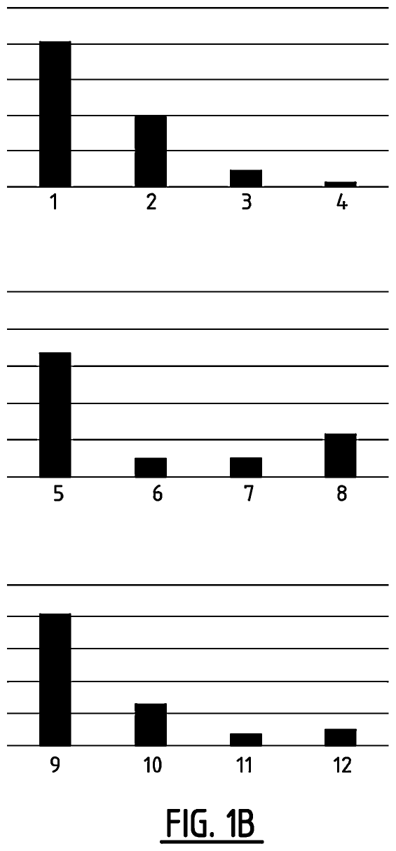

FIG. 1 illustrates the variability in the levels of resistance to short-term ageing of different bitumens provided to them by different individual additives.

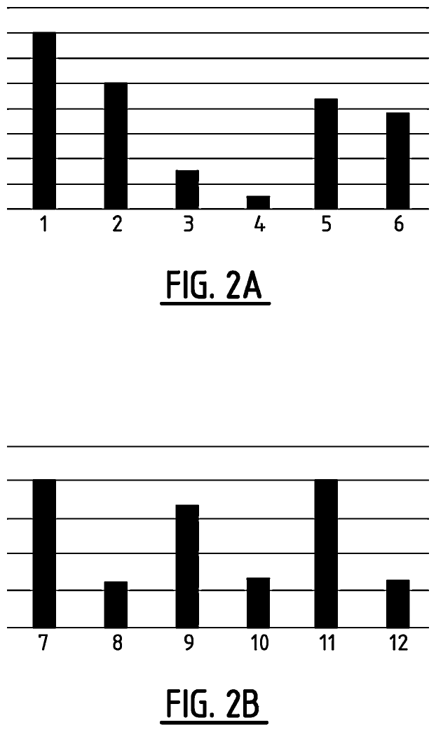

FIG. 2 illustrates the extent of resistance to short-term ageing of different bitumens provided to them by the additive composition according the present invention.

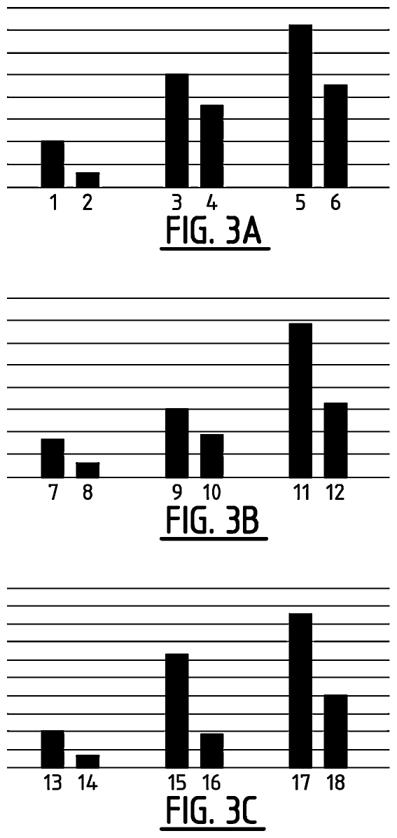

FIG. 3 illustrates the extent of resistance to short- and long-term ageing of a bitumen comprising 0.6% (w/w) of the additive composition according the present invention.

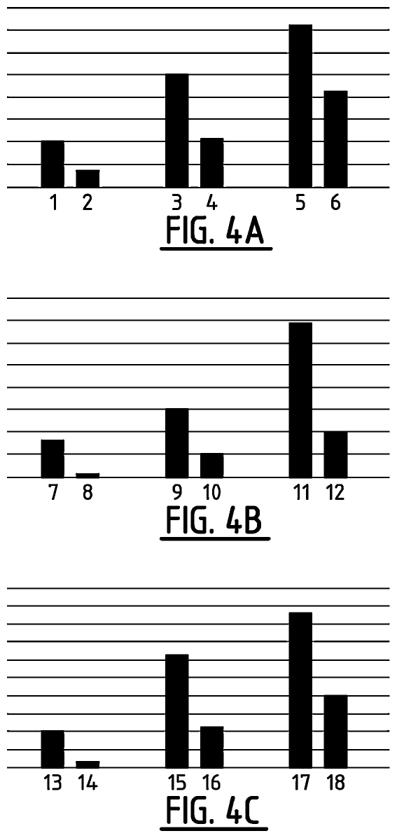

FIG. 4 illustrates the extent of resistance to short- and long-term ageing of a bitumen comprising 1.5% (w/w) of the additive composition according the present invention.

### EXAMPLES

The invention will now be described by reference to examples which are not intended to be limiting of the invention.

Rolling Thin Film Oven Test (“RTFOT”) was used to simulate short-term ageing in bituminous samples, and was carried out in accordance with American Society for Testing and Materials (ASTM) method ‘ASTM D2872’.

Pressure Ageing Vessel (“PAV”) was used to simulate long-term-ageing in bituminous samples, and was carried out in accordance with ASTM method ‘ASTM D6521’.

To assess the extent of ageing in bituminous samples, the softening point in ° C. and the complex shear modulus (G*) in Pa of each bituminous sample with additive(s) were tested before, and after, being subjected to RTFOT or PAV, and the difference in their softening points were calculated. Such value for each sample was subtracted from the difference in softening point of the same bituminous sample without any additive(s) to provide the “reduction in difference in softening point after ageing”, wherein the samples with the highest reduction indicated those samples that comprised the additive(s) that were more effective in providing resistance to ageing. When subjected to similar ageing conditions, the samples with a lower complex shear modulus are preferred. The samples with the lower complex shear modulus indicated those samples that contained the additive(s) that were most effective in providing resistance to ageing.

### Example 1

The extent to which individual additives (anti-oxidants and the asphaltene dispersant) are able to reduce short-term ageing was assessed on different bituminous compositions from different origins, each comprising a single-origin bitumen.

The following additives (together the Additive Composition) were used: tris (2,4-ditert butyl) phenyl phosphite; 3,3′-thiodipropionic acid dioctadecylester (Irganox FL 802); polyethylene glycol monoalkyl ether; and polyethylene glycol monoalkyl ether (Genapol X-80).

To individual 200 ml samples of bitumen from above-mentioned three different sources, 0.6% w/w of tris (2,4-ditert butyl) phenyl phosphite, or 0.6% w/w of 3,3′-thiodipropionic acid dioctadecylester, or 0.6% w/w of polyethylene glycol monoalkyl ether were added and mixed to almost homogeneity. One sample from each bitumen source was reserved as a negative control, having no additive(s) added to it.

Softening point and complex shear modulus (G*) of each sample was measured as described above, and the “reduction in difference in softening point after ageing” was worked out. The complex shear modulus is a rheological parameter used to describes the entire viscoelastic behavior of the sample. The results are set out in Table 1, and displayed in FIG. 1.

FIG. 1 shows the effect of antioxidants on the change in softening point and G* of bitumen after RTFOT, illustrating the variability of the extent to which each additives was effective in proving resistance to short-term ageing to each bituminous compositions.

Table 1 shows the effect of individual antioxidants/asphaltene dispersant on the change in softening point and G* of bitumen after RTFOT.

FIG. 1A y-axis shows the change in softening point after RTFOT in ° C.: Columns 1-4 using Bitumen Sample 1; Columns 5-8 using Bitumen Sample 2; Columns 9-12 using Bitumen Sample 3.

FIG. 1B y-axis shows the increase in G* on ageing compared to unaged sample: Columns 1-5 using Bitumen Sample 1; Columns 5-8 using Bitumen Sample 2; Columns 9-12 using Bitumen Sample 3.

In both FIGS. 1A and 1B, Columns 2, 6 and 10, the samples comprise tris (2,4-ditert butyl) phenyl phosphite; Columns 3, 7 and 11 the samples comprise 3,3′-thiodipropionic acid dioctadecylester (Irganox FL 802); Columns 4, 8 and 12 the samples comprise polyethylene glycol monoalkyl ether (Genapol X-80).

In both FIGS. 1A and 1B, Columns 1, 5 and 9 represent bitumen only control samples.

The results show that the extent to which each one of said additives (anti-oxidant/asphaltene dispersant, as the case may be) individually affects the different bitumen samples to different extents, without any consistency between the bitumens.

### Example 2

The extent of the resistance to short-term ageing of the bituminous composition according to the present invention was assessed on different bituminous compositions, each comprising a single-origin bitumen from different origins, each further comprising tris (2,4-ditert butyl) phenyl phosphite, 3,3′-thiodipropionic acid dioctadecylester (Irganox FL 802), and polyethylene glycol monoalkyl ether (Genapol X-80).

To 200 ml of bitumen sample, 0.2% w/w of each of the following mixture of additives (together the Additive Composition) were added and mixed to almost homogeneity, so that the final additive amount added up to 0.6% to be inline with Example 1: tris (2,4-ditert butyl) phenyl phosphite, 3,3′-thiodipropionic acid dioctadecylester (Irganox FL 802), polyethylene glycol monoalkyl ether (Genapol X-80).

RTFOT was carried out as in Experiment 1, and the reduction in difference in softening point after ageing in ° C. was calculated as was done in Example 1.

The results are set out in Table 2, and displayed in FIG. 2.

Table 2 shows the comparison of individual anti-oxidants and additive compositions on the change of softening point and G* after RTFOT.

FIG. 2A y-axis shows the change in softening point after RTFOT in ° C.: Column 1 using Bitumen Sample 1; Column 3 using Bitumen Sample 2; Column 5 using Bitumen Sample 3.

FIG. 2B y-axis shows the increase in G* on ageing compared to unaged sample Column 7 using Bitumen Sample 1; Column 9 using Bitumen Sample 2; Column 11 using Bitumen Sample 3.

In both FIGS. 2A and 2B, Columns 2, 4, 6, 8, 10 and 12 comprise the Additive Composition.

FIG. 2B shows that the variability in the anti-ageing effects of the individual compounds was no longer as prominent when a mixture of tris (2,4-ditert butyl) phenyl phosphite, 3,3′-thiodipropionic acid dioctadecylester, polyethylene glycol monoalkyl ether was added to the bitumens.

The results show a consistent decrease in the extent of ageing, after being subjected to short-term ageing by RTFOT, in Bitumen Samples which comprise the Additive Composition, compared to the Bitumen Samples without any Additive Composition. This was reflected in both the change in softening point after RTFOT, and the increase in G* after short term ageing.

### Example 3

The extent of the resistance to long-term ageing of the bituminous composition according to the present invention was assessed.

To a bituminous sample, tris (2,4-ditert butyl) phenyl phosphite, 3,3′-thiodipropionic acid dioctadecylester (Irganox FL 802), polyethylene glycol monoalkyl ether (Genapol X-80) were added and mixed to almost homogeneity. To another sample of the same bitumens, no additives were added. Each bitumen sample was subjected to an RTFOT cycle followed by two cycles of PAV. Samples were taken from each bitumen sample before ageing, after the RTFOT, after the first cycle of PAV and after the second cycle of PAV for measurement and calculation.

Each cycle of PAV was carried out at 100° C. for 20 hours at 21 atm., using zero air, as outlined in ASTM D6521.

FIG. 3 shows the extent of the resistance to long-term ageing of the bituminous composition (Bitumen Samples 1, 2 and 3: FIGS. 3A, 3B and 3C respectively) comprising the Additive Composition according to the present invention (Columns 3-6, 9-12 and 15-18).

In FIG. 3A, Columns 1 and 2 represent the effect of without and with the Additive Composition, respectively, on short-term ageing (RTFOT) on Bitumen Sample 1. Columns 3 and 4 represent the effect of without and with the Additive Composition, respectively, on long-term ageing (1 cycle of PAV) on Bitumen Sample 1. Columns 5 and 6 represent the effect of without and with the Additive Composition, respectively, on long-term ageing (2 cycles of PAV) on Bitumen Sample 1.

In FIG. 3B, Columns 7 and 8 represent the effect of without and with the Additive Composition, respectively, on short-term ageing (RTFOT) on Bitumen Sample 2. Columns 9 and 10 represent the effect of without and with the Additive Composition, respectively, on long-term ageing (1 cycle of PAV) on Bitumen Sample 2. Columns 11 and 12 represent the effect of without and with the Additive Composition, respectively, on long-term ageing (2 cycles of PAV) on Bitumen Sample 2.

In FIG. 3C, Columns 13 and 14 represent the effect of without and with the Additive Composition, respectively, on short-term ageing (RTFOT) on Bitumen Sample 3. Columns 15 and 16 represent the effect of without and with the Additive Composition, respectively, on long-term ageing (1 cycle of PAV) on Bitumen Sample 3. Columns 17 and 18 represent the effect of without and with the Additive Composition, respectively, on long-term ageing (2 cycles of PAV) on Bitumen Sample 3.

The consistently lower G* observed for Bitumen Samples comprising the Additive Composition, after both short- and long-term ageing, compared to the Bitumen Samples without any Additive Composition. This demonstrated the consistent effect of the Additive Composition in controlling the extent of ageing over an extended ageing time.

### Example 4

The extent of the resistance to short and long-term ageing of the bituminous composition at higher Additive Composition concentration according to the present invention was assessed in the same manner as Example 3.

To the abovementioned three Bitumen Samples, the Additive Composition comprising tris (2,4-ditert butyl) phenyl phosphite, 3,3′-thiodipropionic acid dioctadecylester, polyethylene glycol monoalkyl ether (each additive at an amount of 0.5% w/w in 200 ml bitumen mixed to almost homogeneity) was added. To another sample of the each of the three same Bitumen Samples, no additives were added, as control samples. Each bitumen sample was subjected to an RTFOT cycle, and two cycles of PAV. Samples were taken from each bitumen sample before ageing, after the RTFOT, after the first cycle of PAV and after the second cycle of PAV, and measured and calculated.

Each cycle of PAV was carried out at 100° C. for 20 hours at 21 atm., using zero air, as outlined in ASTM D6521.

FIG. 4 shows extent of the resistance to short and long-term ageing of the bituminous composition containing 1.5% (w/w) of the Additive Composition, according to the present invention.

In FIG. 4A, Columns 1 and 2 represent the effect of without and with the Additive Composition, respectively, on short-term ageing (RTFOT) on Bitumen Sample 1. Columns 3 and 4 represent the effect of without and with the Additive Composition, respectively, on long-term ageing (1 cycle of PAV) on Bitumen Sample 1. Columns 5 and 6 represent the effect of without and with the Additive Composition, respectively, on long-term ageing (2 cycles of PAV) on Bitumen Sample 1.

In FIG. 4B, Columns 7 and 8 represent the effect of without and with the Additive Composition, respectively, on short-term ageing (RTFOT) on Bitumen Sample 2. Columns 9 and 10 represent the effect of without and with the Additive Composition, respectively, on long-term ageing (1 cycle of PAV) on Bitumen Sample 2. Columns 11 and 12 represent the effect of without and with the Additive Composition, respectively, on long-term ageing (2 cycles of PAV) on Bitumen Sample 2.

In FIG. 4C, Columns 13 and 14 represent the effect of without and with the Additive Composition, respectively, on short-term ageing (RTFOT) on Bitumen Sample 3. Columns 15 and 16 represent the effect of without and with the Additive Composition, respectively, on long-term ageing (1 cycle of PAV) on Bitumen Sample 3. Columns 17 and 18 represent the effect of without and with the Additive Composition, respectively, on long-term ageing (2 cycles of PAV) on Bitumen Sample 3.

The Bitumen Samples comprising an increased concentration of the Additive Composition resulted in a further reduction in the impact of ageing, both short- and long-term ageing, compared to that observed with a Bitumen Samples with a lower concentration of the Additive Composition.

TABLE 1
Effect of individual antioxidants/asphaltene dispersant on the change
in softening point and G* of bitumen after RTFOT

| | | +Tris (2,4-di | | |
|---|---|---|---|---|
| | | tert butyl | | |
| | Bitumen | phenyl- | +Irganox | +Genapol |
| Bitumen 1 | only | phosphite) | FL 802 | X-80 |
| Softening point (° C.) | 57.8 | 59.6 | 57.4 | 57 |
| Softening point after | 64.8 | 63.8 | 62.8 | 62 |
| RTFOT (° C.) | | | | |
| Change in softening | 7 | 4.2 | 5.4 | 5 |
| point after RTFOT | | | | |
| (° C.) | | | | |
| G* increase after | 203 | 97 | 22 | 6 |
| RTFOT (%) | | | | |
| | | +Tris (2,4-di | | |
| | | tert butyl | | |
| | Bitumen | phenyl- | +Irganox | +Genapol |
| Bitumen 2 | only | phosphite) | FL 802 | X-80 |
| Softening point (° C.) | 93.5 | 93 | 91 | 90 |
| Softening point after | 95 | 93.5 | 94 | 90 |
| RTFOT (° C.) | | | | |
| Change in softening | 1.5 | 0.5 | 3 | 0 |
| point after RTFOT | | | | |
| (° C.) | | | | |
| G* increase after | 167 | 26 | 26 | 58 |
| RTFOT (%) | | | | |
| | | + Tris (2,4-di | | |
| | | tert butyl | | |
| | Bitumen | phenyl- | +Irganox | +Genapol |
| Bitumen 3 | only | phosphite) | FL 802 | X-80 |
| Softening point (° C.) | 49 | 49.4 | 50 | 48.6 |
| Softening point after | 53.4 | 54.8 | 54.4 | 52.4 |
| RTFOT (° C.) | | | | |
| Change in softening | 4.4 | 5.4 | 4.4 | 3.8 |
| point after RTFOT | | | | |
| (° C.) | | | | |
| G* increase after | 203 | 63 | 17 | 24 |
| RTFOT (%) | | | | |

TABLE 2
The effect of the Additive Composition on the change of softening
point and G* after RTFOT

| | | Bitumen |
|---|---|---|
| | | + Additive |
| Bitumen 1 | Bitumen only | Mixture |
| Softening point (° C.) | 57.8 | 57.4 |
| Softening point after RTFOT (° C.) | 64.8 | 62.4 |
| Change in softening point after RTFOT | 7 | 5 |
| (° C.) | | |
| G* increase after RTFOT (%) | 203 | 62 |
| | | Bitumen |
| | | + Additive |
| Bitumen 2 | Bitumen only | Mixture |
| Softening point (° C.) | 93.5 | 91.5 |
| Softening point after RTFOT (° C.) | 95 | 92 |
| Change in softening point after RTFOT | 1.5 | 0.5 |
| (° C.) | | |
| G* increase after RTFOT (%) | 167 | 68 |
| | | Bitumen |
| | | + Additive |
| Bitumen 3 | Bitumen only | Mixture |
| Softening point (° C.) | 49 | 48.4 |
| Softening point after RTFOT (° C.) | 53.4 | 52.2 |
| Change in softening point after RTFOT | 4.4 | 3.8 |
| (° C.) | | |
| G* increase after RTFOT (%) | 203 | 67 |

TABLE 3
The extent of the resistance to short- and long-term ageing of the
bituminous compositions with the Additive Composition

| | | Bitumen + |
|---|---|---|
| | | Additive |
| Bitumen 1 | Bitumen only | Composition |
| Stiffness increase after RTFOT (%) | 203 | 62 |
| Stiffness increase after 1 cycle of | 511 | 363 |
| the PAV (%) | | |
| Stiffness increase after 2 cycles of | 725 | 456 |
| the PAV (%) | | |
| | | Bitumen + |
| | | Additive |
| Bitumen 2 | Bitumen only | Composition |
| Stiffness increase after RTFOT (%) | 167 | 68 |
| Stiffness increase after 1 cycle of | 312 | 190 |
| the PAV ( %) | | |
| Stiffness increase after 2 cycles of | 690 | 336 |
| the PAV (%) | | |
| | | Bitumen + |
| | | Additive |
| Bitumen 3 | Bitumen only | Composition |
| Stiffness increase after RTFOT (%) | 203 | 67 |
| Stiffness increase after 1 cycle of | 630 | 184 |
| the PAV ( %) | | |
| Stiffness increase after 2 cycles of | 859 | 402 |
| the PAV (%) | | |

TABLE 4
The extent of the resistance to short and long-term ageing of the
bituminous composition at higher Additive Composition concentrations

| | | Bitumen 1 + |
|---|---|---|
| | | Additive |
| Formulations | Bitumen 1 | composition |
| Stiffness increase after RTFOT (8) | 203 | 72 |
| Stiffness increase after 1 cycle of the PAV (8) | 511 | 216 |
| Stiffness increase after 2 cycles of the PAV (8) | 725 | 427 |
| | | Bitumen 2 + |
| | | Additive |
| Formulations | Bitumen 2 | composition |
| Stiffness increase after RTFOT (%) | 167 | 13 |
| Stiffness increase after 1 cycle of the PAV | 312 | 105 |
| compared to the unaged sample (%) | | |
| Stiffness increase after 2 cycles of the PAV | 690 | 196 |
| compared to the unaged sample (%) | | |
| | | Bitumen 3 + |
| | | Additive |
| Formulations | Bitumen 3 | composition |
| Stiffness increase after RTFOT (8) | 203 | 34 |
| compared to the unaged sample (%) | | |
| Stiffness increase after 1 cycle of the PAV | 630 | 235 |
| compared to the unaged sample (%) | | |
| Stiffness increase after 2 cycles of the PAV | 859 | 403 |
| compared to the unaged sample (%) | | |

1. An additive composition, wherein the additive composition comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is a polyalkylene glycol monoalkyl ether glycol monoalkyl ether.

2. The additive composition according to claim 1, wherein the polyalkylene glycol monoalkyl ether is polyethylene glycol monoalkyl ether.

3. A bituminous composition comprising anti-oxidants and an asphaltene dispersant, wherein the anti-oxidants are tris (2,4-ditert butyl) phenyl phosphite and 3,3′-thiodipropionic acid dioctadecylester; and wherein the asphaltene dispersant is polyethylene glycol monoalkyl ether.

4. The bituminous composition according to claim 3, wherein each of the anti-oxidants and the asphaltene dispersant is present at range of from 0.05% w/w to 2% w/w with respect to the bituminous composition.

5. The bituminous composition according to claim 3, wherein each of the anti-oxidants and the asphaltene dispersant is present at range of from 0.15% w/w to 1.75% w/w with respect to the bituminous composition.

6. An asphalt composition comprising the bituminous composition of any one of claims 3 to 5.

7. Use of an additive composition to reduce short- and long-term ageing of a bituminous composition, wherein the additive composition comprises anti-oxidants and an asphaltene dispersant, wherein the anti-oxidants are tris (2,4-ditert butyl) phenyl phosphite and 3,3′-thiodipropionic acid dioctadecylester, and wherein the asphaltene dispersant is polyethylene glycol monoalkyl ether.

8. The use of an additive composition according to claim 7, wherein each of the anti-oxidants and the asphaltene dispersant, when incorporated into the bituminous composition, is present at range of from 0.05% w/w to 2% w/w with respect to the bituminous composition.

9. The use of an additive composition according to claim 7, wherein each of the anti-oxidants and the asphaltene dispersant, when incorporated into the bituminous composition, is present at range of from 0.15% w/w to 1.75% w/w with respect to the bituminous composition.
